(19) United States
(12) Patent Application Publication
(10) Pub. No.: US 2024/0293936 A1
(43) Pub. Date: Sep. 5, 2024

(54) USE OF ROBOTIC ARM TO ACHIEVE PACKING DENSITY

(71) Applicant: Dexterity, Inc., Redwood City, CA (US)

(72) Inventors: Wen Hsuan Hsieh, Los Altos, CA (US); Samir Menon, Menlo Park, CA (US); Zhouwen Sun, San Mateo, CA (US); Shitij Kumar, Santa Clara, CA (US); Andrew Bylard, San Mateo, CA (US)

(21) Appl. No.: 18/593,645

(22) Filed: Mar. 1, 2024

Related U.S. Application Data
(60) Provisional application No. 63/449,318, filed on Mar. 2, 2023.

(51) Int. Cl. B25J 9/16; B65G 61/00

(52) U.S. Cl. CPC B25J 9/1687; B25J 9/1612; B25J 9/1633; B25J 9/1697; B65G 61/00

(57) ABSTRACT

A robotic system is disclosed. In various embodiments, sensor data is received. A plan is determined, based at least in part on the received sensor data, to use a robotic arm to build a stack of items comprising a plurality of items, the plan including with respect to at least a subset of the items a plan to move the item to an initial position on the stack and then reposition and use the robotic arm to pack the item more snugly against an adjacent surface. The plan is implemented at least in part by sending one or more commands to a robotic arm.

### CROSS REFERENCE TO OTHER APPLICATIONS

This application claims priority to U.S. Provisional Patent Application No. 63/449,318 entitled USE OF ROBOTIC ARM TO ACHIEVE PACKING DENSITY filed Mar. 2, 2023 which is incorporated herein by reference for all purposes.

### BACKGROUND OF THE INVENTION

Robotic systems have been disclosed to stack items, e.g., on a pallet, or load them into a truck or other container with rigid sides. For loading things like boxes or packages in an enclosed container, e.g., a truck or a cart with walls, the desired outcomes typically include one or more of optimal utilization of space, e.g., higher density, and stability or tightness to prevent packages from moving during transport.

A human operator loading boxes in an enclosed container ‘stacks’ and ‘packs’ the boxes. Typically, a human worker may be observed to place an item on a stack, and then push or press it into a position more snugly in contact with adjacent items and/or the container sides, for example. However, automating both these actions (i.e., stack and pack) to be performed together by a robot is challenging.

In prior approaches, robots have been used to stack boxes or other packages that are rigid and uniform, and therefore readily able to be stacked compactly, and/or robots have been used to stack items in used cases that allowed them to use smart structurally strategic placements and using the side walls of the enclosed container for support.

For example, a packing algorithm may be used to select a placement location for each box in an arriving sequence of boxes. A robotic arm with a suction type gripper, for example, may be used to grasp each box, e.g., at the top of the box, and place it as closely as possible in its intended location/orientation, as determined by the packing algorithm. However, the placement may not be exactly where/as intended, and gaps and misalignments may accumulate over time, resulting in lack of density and instability.

Techniques have been described previously to use computer vision to perform a first order (gross) placement and then use force control to snug a box or other item into place. However, instability and lack of density can occur, e.g., due to small errors in placement of each box (or a subset) that have a cumulative effect, such as lower than desired density, instability, etc.

### BRIEF DESCRIPTION OF THE DRAWINGS

Various embodiments of the invention are disclosed in the following detailed description and the accompanying drawings.

FIG. 1 is a block diagram of a robotic system configure to use a robotic arm or other robotic instrumentality to achieve packing density.

FIG. 2 is a flow diagram illustrating an embodiment of a process to use a robotic arm or other robotic instrumentality to achieve packing density.

FIG. 3 is a flow diagram illustrating an embodiment of a process to detect and respond to detected lack of density and/or instability.

FIG. 4 is a flow diagram illustrating an embodiment of a process to stack and pack items using a robotic arm or other robotic instrumentality.

FIG. 5 is a diagram illustrating an example of using a robotic arm or other robotic instrumentality to achieve packing density.

FIG. 6 is a diagram illustrating an example of using a robotic arm or other robotic instrumentality to achieve packing density.

FIG. 7 is a diagram illustrating an example of using a robotic arm or other robotic instrumentality to achieve packing density.

FIG. 8 is a diagram illustrating an example of using a robotic arm or other robotic instrumentality to achieve packing density.

FIG. 9 is a diagram illustrating an example of using a robotic arm or other robotic instrumentality to achieve packing density.

FIG. 10 is a block diagram illustrating an embodiment of a control computer configured to operate a robotic arm or other robotic instrumentality to achieve packing density.

FIG. 11 is a diagram illustrating an example of using computer vision to detect and respond to excessive box deformation.

FIG. 12 is a diagram illustrating an embodiment of a robotic end effector having retractable/deployable structures to push boxes or other items to achieve packing density and/or stability.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to use a robot, such as a robotic arm, or two or more robots or a single robot with two or more robotic arms, cooperatively to “stack and pack” boxes or other items on a pallet or in a truck or other container. As in prior approaches, a packing algorithm may be used to select a placement location for each box. One or more robotic arms may be used to pick each box or other item from a source location and place it in the location and orientation determined by the packing algorithm (“stack”). In various embodiments, the packing algorithm is augmented or modified to include using the robotic arm or other robotically controlled instrumentality to push or pull on one or more boxes (or other items) to achieve or maintain packing density (“pack”).

In some embodiments, pushing/pulling to pack more densely may be done in response to a state estimation of the boxes/items stack on the pallet or in the truck/container indicating an unexpected and/or undesirable gap may exist, e.g., behind a box. Image data from one or more cameras in the workspace or mounted on the robotic arm may be used to detect a gap. For example, a camera mounted in the workspace may see a space, a robotic arm may move a robot-mounted camera into a position to see/better see space, image data may indicate box(es) not in an expected position/orientation, detect leaning towers, crushed box(es), or other instability, etc.

In various embodiments, a new placement strategy is implemented that not only leverages placements but also uses force feedback to push the boxes or other items to have more support and tightness by using not just the walls of the truck/container but other boxes as well. In various embodiments, this is achieved by creating a stack of stable boxes and applying direction forces to pack them such to maximize the number of surfaces a box is supported from In various embodiments, a vision system is used to estimate the direction and amount of push needed, and sensor feedback of forces experienced at the end-of-arm-tool (i.e., “end effector”) and the robot joints are used to apply the needed force and detect when an adjacent box or wall is reached.

In various embodiments, stacking and/or packing decisions are made not just for each box but for the entire wall/stack of boxes. A vision and state estimation system identifies gaps and determines the direction of packing to maximize a combination of pallet/stack density, stability, and box health. For example, the system may try to maximize the number of surfaces of boxes are in contact and supported by other boxes or a wall of the container.

The poses and shapes of the boxes the system stacks on the pallet or in truck/container may change as more boxes are added, e.g., due to deformation, or the desired or intended box pose may not be achieved on initial placement. This may provide opportunities to re-optimize the pallet/stack by pushing boxes into new poses and shapes.

For example, as boxes are added, new gaps may arise into which the system may determine to push previously placed boxes. This often happens when a tower of boxes starts leaning over further and further as boxes are added. If a box tower begins leaning away from the pallet/stack, the robot may be used to push the boxes against the lean to fill the gap created by the lean and better stabilize the tower, for example.

Example scenarios and responses, in various embodiments:
Tower scenario: A tower of boxes begins leaning over. The system may determine to push the boxes in the middle of the tower relative to each other, to rebalance the tower's weight distribution and stabilize it.
Fallen box scenario: The system may use the robot to push fallen box(es) into a reasonable placement position on the floor, rather than performing a full (slower) pick-place task; replan to stack other boxes on them.

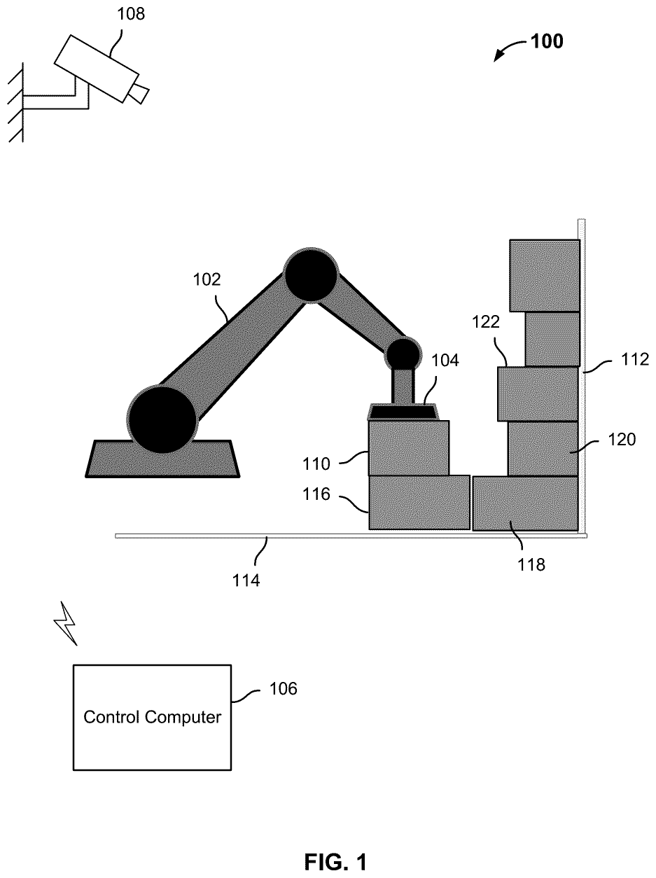

FIG. 1 is a block diagram of a robotic system configure to use a robotic arm or other robotic instrumentality to achieve packing density. In the example shown, system and environment 100 includes a robotic arm 102 having a suction type end effector 104 being operated autonomously under control of a control computer 106. Control computer 106 uses image data from one or more cameras 108, e.g., 3D cameras that provide RGB pixels (2D images) and depth pixels, to construct and maintain a three-dimensional view of the work space. Control computer 106 may use image data from camera(s) 108 to estimate the state (e.g., stability, limits, position of individual boxes, etc.) of a stack of boxes or other items being built using robot 102. In the example shown, boxes (e.g., 110, 116, 118, 120, 122) are being loaded into a truck or other container having a rigid back wall 112 and floor 114.

In the state shown in FIG. 1, robotic arm 102 and end effector 104 are being used to place box 110 on top of box 116. Box 116 is positioned snugly adjacent to box 118, which forms the base of a tower of boxes 118, 120, 122, etc. positioned against the back wall 112. In various embodiments, techniques disclosed herein may be used by control computer 106 to achieve and maintain stability and/or density. For example, box 110 may be placed as shown and then pushed or pulled across the top of box 116 to a position at least partly on top of box 118.

In various embodiments, the control computer 106 may generate a plan to stack box 110 on top of box 116 and then, in a second action, push or drag the box 110 across the top of box 116 into a position that straddles both boxes 116 and 118, thereby achieving greater stability and density.

In some embodiments, image data from camera 108 may be used to detect the gap behind box 110, as initially placed (e.g., as shown in FIG. 1), and a further/separate plan to push the box 110 further back may be generated to eliminate/reduce the detected gap to achieve better stability and/or density.

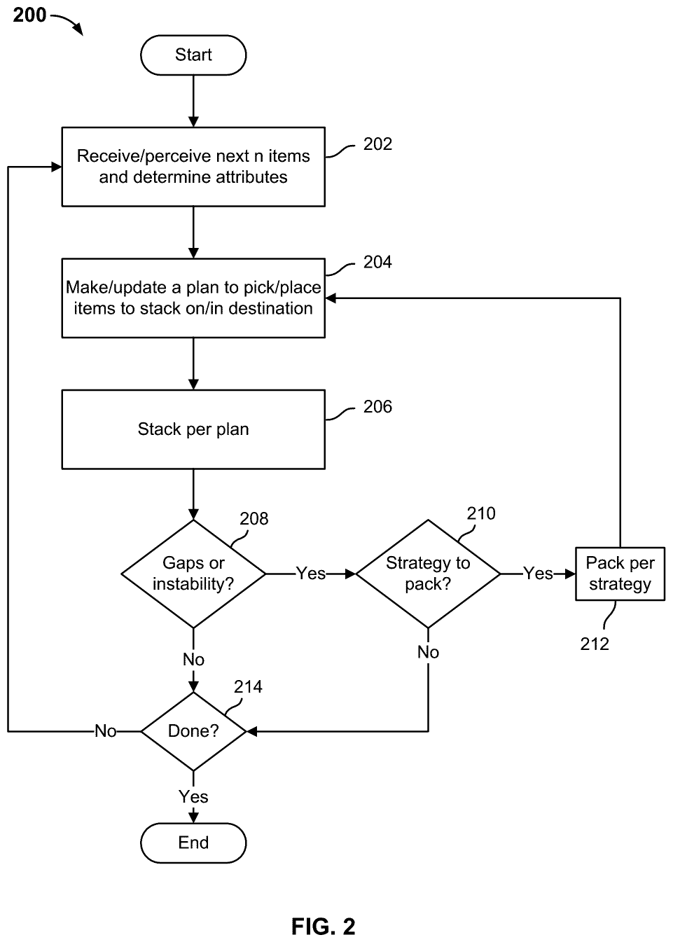

FIG. 2 is a flow diagram illustrating an embodiment of a process to use a robotic arm or other robotic instrumentality to achieve packing density. In various embodiments, the process 200 of FIG. 2 may be implemented by a control computer comprising a robotic system, such as control computer 106 of FIG. 1. In the example shown, at 202, the next n items to be stacked are perceived and their respective attributes are determined. For example, items may be supplied to a robotic system via a conveyor, chute, or other structure. A camera, such as camera 108 of FIG. 1, may generate images that enable one or more attributes of each item to be determined. For example, the size, dimensions, weight, rigidity, etc. of each item may be determined. A label on the item may be read and may contain attribute information or information usable to perform a look up to determine attribute information.

At 204, a plan is determined/updated to pick/place the items, e.g., to stack them on or in a destination, as in the example shown in FIG. 1. The plan may include one or more actions to “pack” the items more densely in the destination. At 206, as the items arrive they are picked and placed according to the plan.

At 208, it is determined whether any gaps and/or instability are detected. For example, image data may be used to estimate the state of the stack and/or items comprising the stack. If the perceived/estimated actual state is different from the expected state—e.g., the state that was expected to be achieved by implementing the plan determined/updated at 204—then a determination may be made at 208 that a gap and/or instability may exist. If a gap/instability is detected at 208 and it is determined at 210 that a strategy is available to use the robotic arm(s) to fill the gap, achieve greater density and/or stability etc., then at 212 the determined strategy is implemented to “pack” the items more densely and/or stably.

In various embodiments, a strategy to pack items more densely and/or stably may be learned by a robotic system as disclosed herein, e.g., via machine learning. In some embodiments, during a training phase a human operator may operate the robotic arm(s) to stack/pack with high density and/or stability and/or to address situations in which gaps and/or instability are present. The robotic system observes the operation of the robotic arm(s) by the human user and learns strategies to be applied in various contexts to achieve greater density and/or stability. In some embodiments, a system as disclosed herein may apply one or more heuristics to achieve greater density and/or stability, such as to push or pull items to fill perceived or otherwise detected gaps, to push items into place until a prescribed level of force opposing further movement is encountered, to stack an item (when possible) in a position that straddles two or more items, etc.

If there are no gaps or instability detected at 208 and/or if it is determined at 210 that a strategy to increase density and/or stability is not available, then the system continues perceiving items as they arrive and making/implementing plans to stack/pack them (202, 204, 206) until it is determined at 214 that no further items remain to be stacked, upon which the process 200 ends.

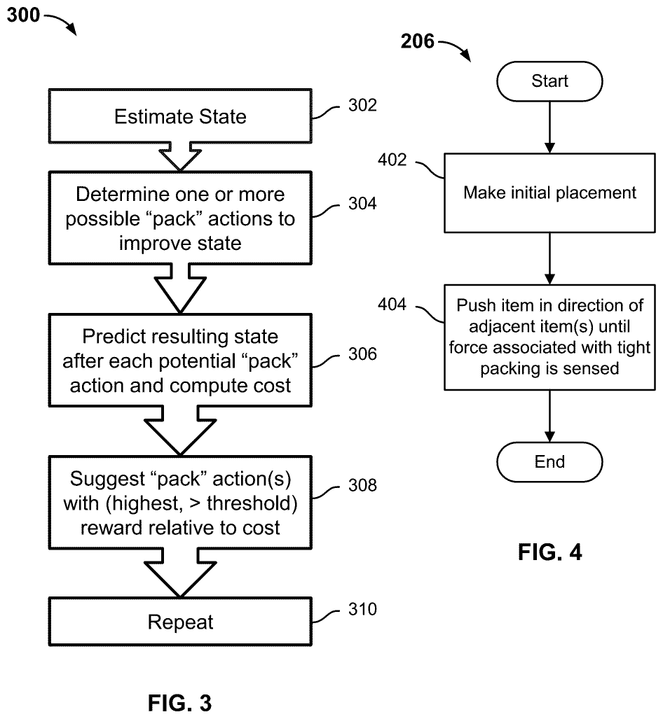

FIG. 3 is a flow diagram illustrating an embodiment of a process to detect and respond to detected lack of density and/or instability. In various embodiments, the process 300 of FIG. 3 may be implemented by a control computer comprising a robotic system, such as control computer 106 of FIG. 1. In some embodiments, the process 300 of FIG. 3 may implement one or more steps of the process 200 of FIG. 2, e.g., steps 208 and 210.

In the example shown in FIG. 3, at 302 a state of the stack being built by the robotic system is estimated. At 304, one or more possible “pack” actions to improve state may be determined. For example, at 304, one or more actions to use the robotic arm(s) to achieve greater density and/or stability may be determined. At 306, for each potential “pack” action determined at 304, the state that would result from performing that pack action is predicted and the associated cost to perform the pack action is computed. At 308, pack actions that have the highest predicted benefit/reward relative to the associated cost are suggested. The steps 302, 304, 306, and 308 are repeated as/if needed (310) until processing is completed.

In various embodiments, one or more cameras positioned in the workspace and/or mounted on the robotic arm or other robot generate image data (e.g., RGB image pixels and depth pixels/point clouds). A computer vision system uses the image/depth data to generate and update a three-dimensional view of the workspace. The vision system may be used to detect gaps, instability, deviations from expected state, etc., as described above in connection with FIG. 3.

In various embodiments, the vision and state estimation system has the following inputs/outputs:
Inputs:
   Vision data (RGB/point clouds/etc.) from various cameras (mounted to mobile chassis, on a pole or other superstructure on the chassis, mounted to grippers, etc.)
   Knowledge of the placed boxes, e.g.:
      Their nominal dimensions, weight, center of mass location, stiffness, and/or other properties
      Their original intended place and pose on the pallet or stack
Outputs:
   The estimated deformed shape of each box on the pallet (simplified primitive shape, triangle mesh, etc.)—e.g., based on weight of boxes on top of it
   The estimated pose of each box on the pallet
   Estimated regions of free space (gaps) in the pallet that boxes may be able to be nudged into

In various embodiments, a computer vision and/or state estimation module or subsystem as disclosed herein may be able to detect gaps that may be occluded/impossible to see directly with vision. For example, a box seen sticking out from stack further than expected may indicate a (possibly occluded) gap behind.

In various embodiments, a pallet/stack state prediction module (e.g., software module) predicts how different pack strategies will affect the future poses/shapes of boxes once they've been stacked. In various embodiments, the module predicts whether the arm/end effector can perform a strategy to pack the box(es) more densely, stably, etc. (e.g., do we have enough force capability? Have we been configured with or learned a strategy that might work in this observed condition?).

In various embodiments, the state prediction module predicts whether the boxes that forces are being applied to will be damaged by the applied forces; if so, different strategy sought/used, or less dense packing tolerated, or if needed human intervention prompted (e.g., potentially damaging instability for which system cannot determine a strategy to rectify.

FIG. 4 is a flow diagram illustrating an embodiment of a process to stack and pack items using a robotic arm or other robotic instrumentality. In various embodiments, the process of FIG. 4 may be used to implement step 206 of the process 200 of FIG. 2. In the example shown, at 402 an initial placement is made. For example, a placement as determined using a packing algorithm may be made, to a first order, by using computer vision to move the item into a first position, near the placement location/orientation, and then using force control or other fine control to place the item initially. At 404, the robotic arm and/or end effector is used, in a second operation, to (further) pack the item tightly against one or more adjacent surfaces, e.g., a container side or back wall and/or one or more adjacent items on the stack. For example, at 404 the end effector and/or a link or joint comprising the robotic arm may be used to push the item more snugly into place. Or the robotic arm may be used to pull or drag the item into place.

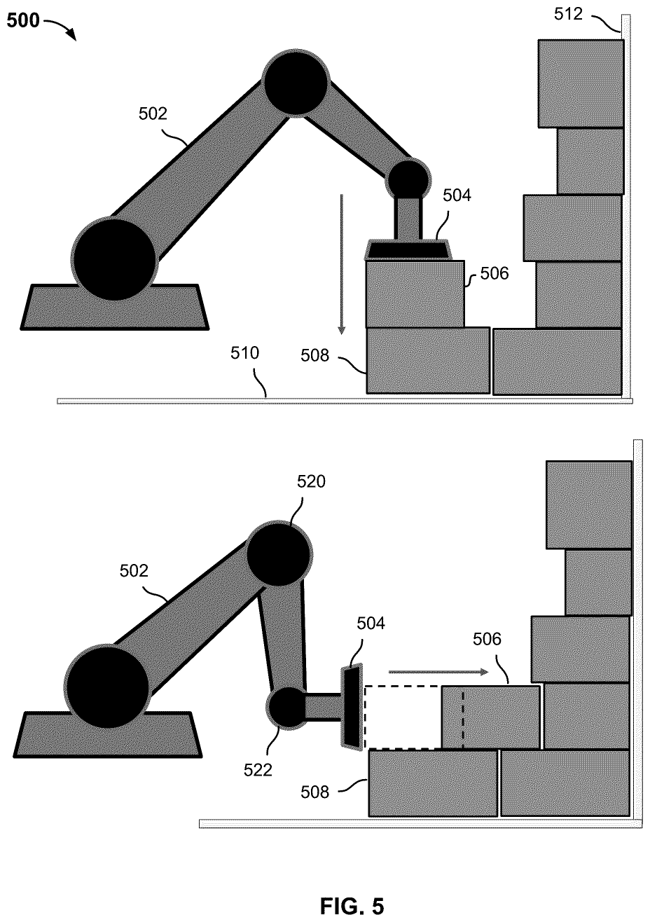

FIG. 5 is a diagram illustrating an example of using a robotic arm or other robotic instrumentality to achieve packing density. In the example shown, system and environment 500 includes a robotic arm 502 with a suction-based end effector 504 used to pick and place a box 506 on an initial location on top of box 508, as illustrated in the upper part of FIG. 5. The boxes (506, 508) are included in a stack being formed in a truck or other container defined in part by floor 510 and back wall 512. The robotic arm 502 and end effector 504 (suction face, as shown, or side of end effector) are then repositioned and used, as shown in the lower part of FIG. 5, to push the box 506 into a final location to achieve higher density and/or stability. In various embodiments, the robotic arm 502 and end effector 504 may be used to push the box 506 until it is observed (e.g., via computer vision) to be in the desired end position and/or until an amount of force associated with tight packing is detected to be pushing back against the robotic arm 502 and end effector 504.

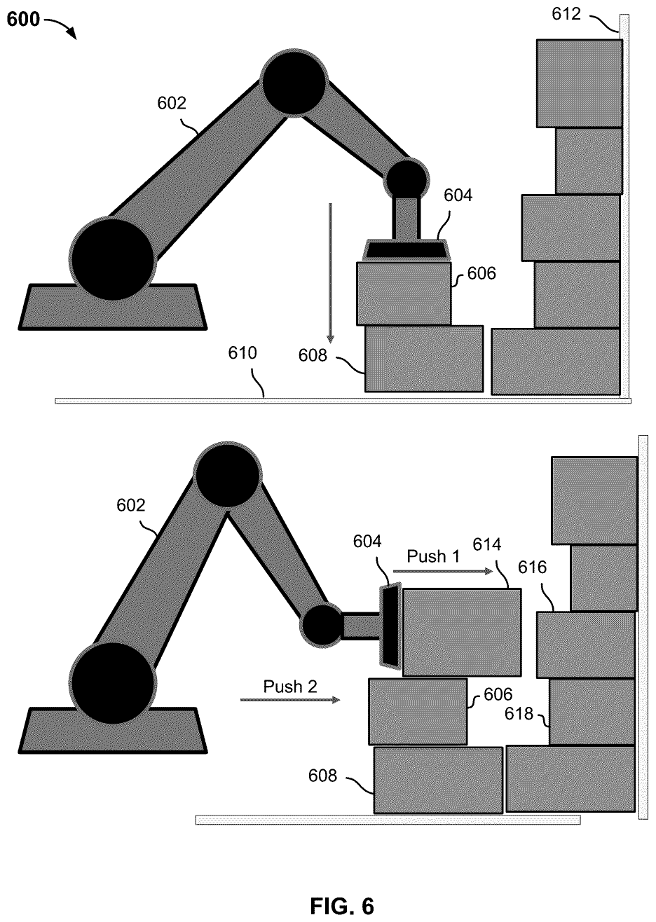

FIG. 6 is a diagram illustrating an example of using a robotic arm or other robotic instrumentality to achieve packing density. In the example shown, system and environment 600 includes a robotic arm 602 with a suction-based end effector 604 used to pick and place a box 606 on an initial location on top of box 608, as illustrated in the upper part of FIG. 6. The boxes (606, 608) are included in a stack being formed in a truck or other container defined in part by floor 610 and back wall 612. A second box 614 is then stacked on top of box 606, resulting in the arrangement as shown in the bottom part of FIG. 6. The robotic arm 602 and end effector 604 (suction face, as shown, or side of end effector) are then repositioned and used, as shown in the lower part of FIG. 6, to first push box 614 into a position snugly in contact with box 616 and then push the box 606 into a final location in contact with box 618, to achieve higher density and/or stability. While boxes 606 and 614 are pushed successively, as described above, in an alternative approach the boxes 606 and 614 may be pushed at the same time, or box 606 may be pushed first followed by box 614 as/if needed.

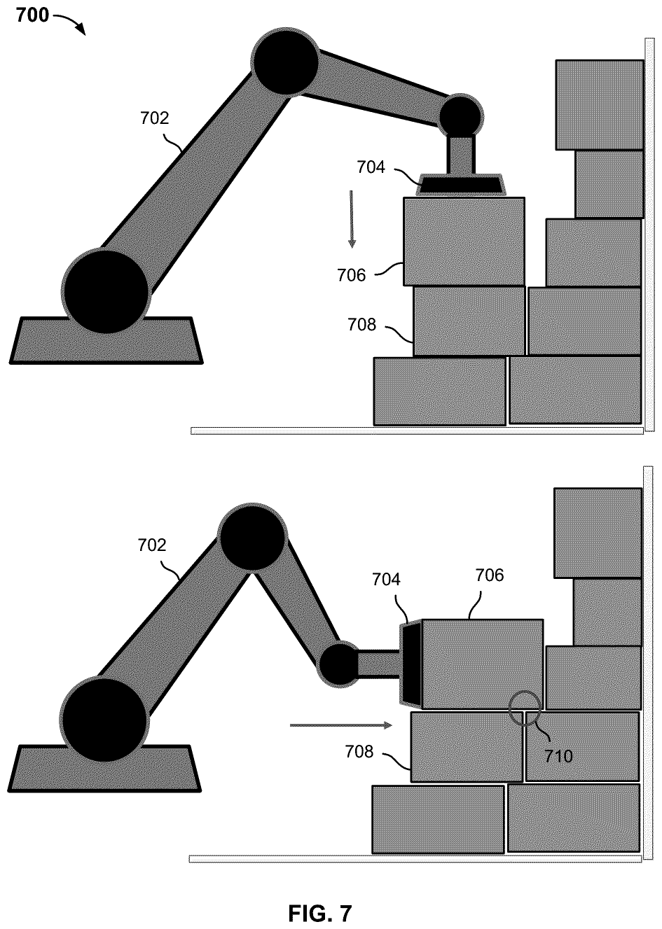

FIG. 7 is a diagram illustrating an example of using a robotic arm or other robotic instrumentality to achieve packing density. In the example shown, system and environment 700 includes a robotic arm 702 with a suction-based end effector 704 used to pick and place a box 706 on an initial location on top of box 708, as illustrated in the upper part of FIG. 7. The end effector 704 is then reoriented and used to push the box 706 into a position as shown in the lower part of FIG. 7 to achieve higher density and/or stability, including in this example by ensuring the box is supported by more than one box below (red circle 710). In various embodiments, ensuring a box is supported by more than one box below achieves greater stability, e.g., as compared to building a tower of boxes each supported only by one box below.

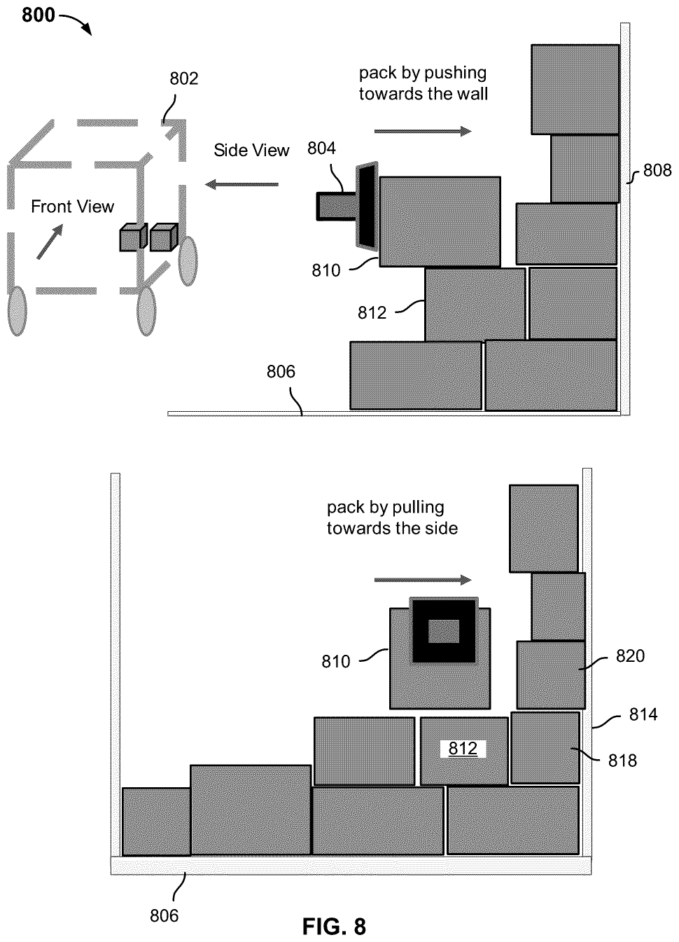

FIG. 8 is a diagram illustrating an example of using a robotic arm or other robotic instrumentality to achieve packing density. In the example shown, system and environment 800 includes a robotic system configured to load items into a truck 802. The robotic system includes a robotic arm, represented in FIG. 8 by suction type end effector 804. The upper right portion of FIG. 8 shows a side view of items being loaded into the truck 802, the truck being represented by floor 806 and back wall 808. In the example shown, the end effector 804 is being used to push a box 810 from an initial, unstable position atop box 812 into a more secure position nearer to back wall 808. In addition, e.g., at the same time or in a subsequent maneuver, the end effector 804 is being used to grasp box 810 at the front face and move it laterally to the right, toward sidewall 814, as shown in the lower part of FIG. 8. By pushing box 810 in and sliding it to the right, as shown in FIG. 8, box 810 ends up in a position more fully and stably atop box 812.

In various embodiments, box/item may be pushed, pulled, slid left/right, etc. as needed to pack more densely. Ways to actuate the packing, in various embodiments, may include one or more of: Pushing in with the suction or other operative/engagement face of the end effector
Pushing with the side of the end effector
Pushing with a deployable/retractable pusher structure on the end effector
Push the with the robotic arm joints and/or links (e.g., elbow, forearm, wrist)
Pushing in with a linear joint in the gripper
   E.g., gripper (end effector) position at side, linear actuator moves gripper laterally to push
Pusher bar mounted on mobile chassis on which robotic arm is mounted, robotic arm moved or kept out of the way as pusher used to push box into position
   E.g., a “plow” or other pusher type structure mounted at the front of the mobile chassis
   Robotically controlled and actuated in some embodiments; e.g., chassis remains stationary, but pusher actuated

In some cases, a box's pose may need to be adjusted, but the face you would need to push on nudge it in the right direction may be unreachable or blocked. For example, a box fallen too close to the rover (mobile chassis) to push from the side of the box. A box near the ceiling that needs to be nudged left or right could be pulled using front face suction.

In various embodiments, a suction gripper may be used to grasp the box/item from a surface that can be engaged (more readily), e.g., suction used to grasp from the front or side and use robotic arm to pull box/item into position, or slide it laterally into position, as in FIG. 8.

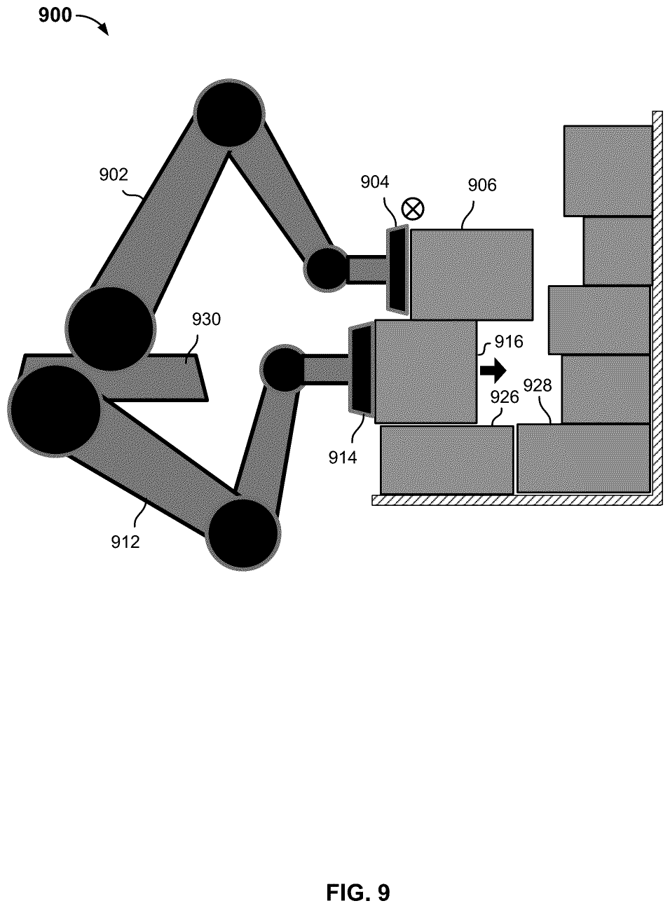

FIG. 9 is a diagram illustrating an example of using a robotic arm or other robotic instrumentality to achieve packing density. In the example shown, robotic system and environment 900 includes two robotic arms 902, 912 mounted on a common (e.g., mobile) chassis 930. In the state shown, robotic arm 902 and end effector 904 are being used to hold box 906 in place while robotic arm 912 and end effector 914 are used to push box 916 along the top surface of box 926 (and sliding under box 906) into a position that straddles boxes 926 and 928. In various embodiments, a first robotic arm may be used to hold a first box in place while a second robotic arm is used to push, pull, or slide a second box into position. Or, in some cases, a first robotic arm may be used to push or hold a first box more snugly in a position in contact with a side or back wall and/or one or more adjacent items, e.g., to create a large enough gap for a second box to be placed in or moved through the gap by using a second robotic arm.

In various embodiments, the first and second robotic arms may be mounted on a common chassis, as in the example shown in FIG. 9, or separately mounted robots may be used in cooperation.

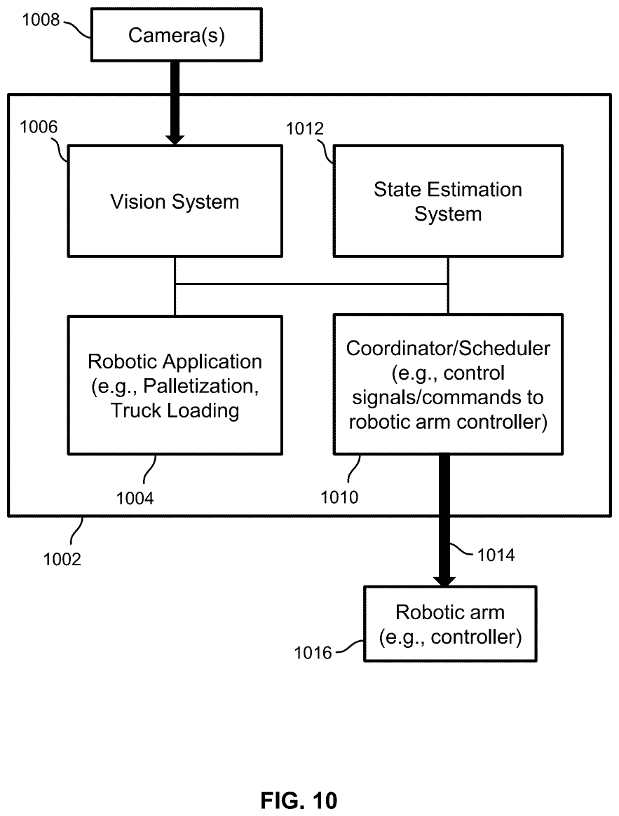

FIG. 10 is a block diagram illustrating an embodiment of a control computer configured to operate a robotic arm or other robotic instrumentality to achieve packing density. In the example shown, control computer 1002 (e.g., an implementation of control computer 106 of FIG. 1) includes the following:
State estimation system 1012 configured to estimate stability, density (or presence/location of gaps), etc. based on what is known about each box and how it has been placed (location, pose/orientation).
Vision system 1006 configured to use image/depth data received from one or more cameras 1008 to see things as they actually are, e.g., deformation or damage to boxes, visible gaps, instability (e.g., leaning).
One or more robotic applications 1004, each comprising logic to load items onto a truck or container or onto pallet.
A coordinator/scheduler 1010 configured to determine a plan to stack items, e.g., according to a packing algorithm, including prediction and decision-making, such as:
   Decide where and how to place each box/item (stack)
   Determine need/opportunity to pack more densely/stably
   Scheduling robotic arm to do stack, pack, etc.

The control computer 1002 uses the above-described modules/systems 1004, 1006, 1010, 1012 to generate commands 1014 to cause the onboard controller 1016 of the robotic arm to operate the robotic arm to implement the stack/pack plan.

In some embodiments and contexts, pallet (stack) state estimation may be imperfect, so the system may not have perfect knowledge of things like the size of gaps that cannot be seen directly with computer vision. In addition, the system may not be able to predict how much friction will be encountered when trying to slide boxes with respect to each other or whether a box may get caught on a protruding edge of another box.

In various embodiments, force feedback is used to detect when a box has been pushed/pulled as far as it can go, or if friction is too high to proceed. In various embodiments, force feedback and/or vision may be used to detect we are damaging a box by pushing on it too hard. For example, vision may be used to detect that a box is being severely deformed by pushing on it. For example, a large deformable box face may collapse in on itself, when pushed, if the box is wedged tight and cannot move easily. In various embodiments, deformation is detected using camera images (e.g., see deformation, see secondary effect of deformation, such as boxes above leaning), and in response to detecting the deformation the robotic system ceases pushing.

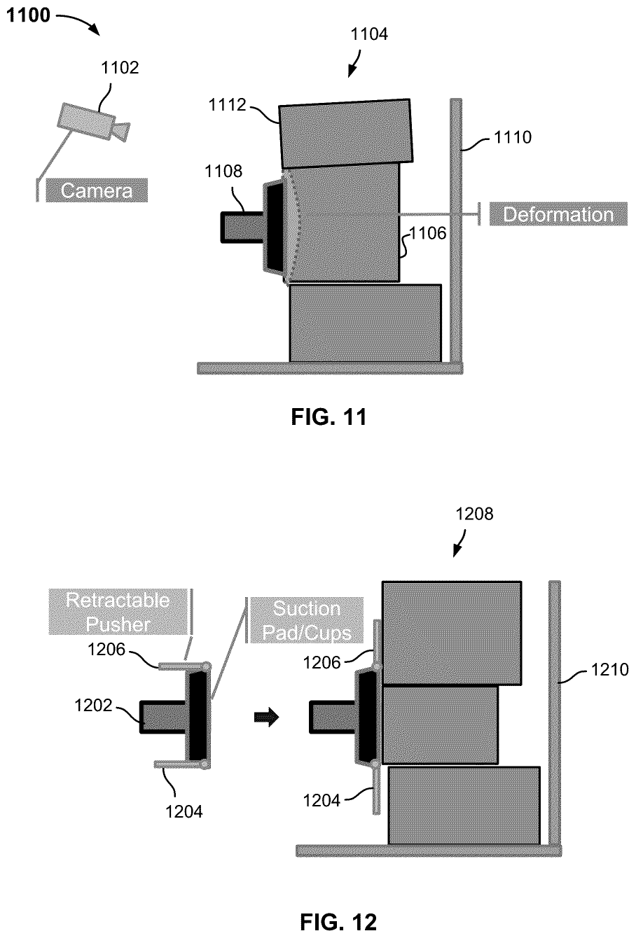

FIG. 11 is a diagram illustrating an example of using computer vision to detect and respond to excessive box deformation. In the example shown, system and environment 1100 includes a camera 1102 position to see boxes 1106, 1112 being stacked 1104. A robotic arm represented in FIG. 11 by end effector 1108 is attempting to be used to push box 1106 closer to back wall 1110, but for some reason the front face of box 1106 is deforming (collapsing). While the deformation may not be seen in images generated by camera 1102, in various embodiments the fact of deformation would be inferred based on image data from camera 1102 indicating that the box 1112 positioned on top of box 1106 is leaning forward (i.e., back towards end effector 1108).

In various embodiments, an end-effector tool is provided to perform stack and pack operations as disclosed herein. For example, the end effector may be designed to include relatively level and/or flat surfaces that can used as pushing surfaces, potentially spanning multiple box faces. Suction surfaces that can used for pulling (e.g., suction grip at front or side), potentially spanning multiple box faces may be included. Force feedback (force sensors in end effector or wrist) may be used to detect box pushing back, e.g., reached another box or adjacent surface. May be a fixed-size gripper or may have deployable features to span multiple boxes, as in the example shown below, in which pusher elements are swept back (at left) when the suction gripper is being used, but deployed (at right) when there is a need to push multiple boxes simultaneously.

FIG. 12 is a diagram illustrating an embodiment of a robotic end effector having retractable/deployable structures to push boxes or other items to achieve packing density and/or stability. In the example shown, end effector 1202 includes a central suction pad or array or suction cups flanked on either side by a retractable pusher bar 1204, 1206. To grasp and move items using suction, the bars 1204, 1206 are retracted, as shown at left. To push one or more boxes, the bars 1204, 1206 may be deployed, as shown at right, and used along with the suction face/cups of the end effector to push one or more boxes, e.g., to push the stack 1208 of boxes simultaneously into a position more snugly adjacent to back wall 1210.

In some cases, a box's pose may need to be adjusted, but the face the robot would need to push on nudge it in the right direction may be unreachable or blocked. For example, a box that has fallen too close to the rover (mobile chassis) to use the robotic arm to push from the side of the box. A box near the ceiling that needs to be nudged left or right could be pulled using front face suction, e.g., as in the example shown in the lower part of FIG. 8. In various embodiments, a suction gripper may be used to grasp the box/item from a surface that can be engaged (more readily), e.g., suction used to grasp from the front or side and use robotic arm to pull box/item into position or slide it laterally into position.

In various embodiments, techniques disclosed herein are used to achieve higher density, greater stability, etc. when stacking boxes or other items, e.g., on a pallet, and/or loading them into a truck or other container.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a communication interface configured to receive sensor data; and
a processor coupled to the communication interface and configured to:
determine, based at least in part on the received sensor data, a plan to use a robotic arm to build a stack of items comprising a plurality of items, the plan including with respect to at least a subset of the items a plan to move the item to an initial position on the stack and then reposition and use the robotic arm to pack the item more snugly against an adjacent surface; and
implement the plan at least in part by sending one or more commands to a robotic arm.

2. The system of claim 1, wherein the robotic arm comprises an end effector and wherein the processor is configured to pack the item more snugly against the adjacent surface at least in part by using the robotic arm to position and use the end effector to push on a side surface of the item.

3. The system of claim 1, wherein the robotic arm comprises an end effector and wherein the processor is configured to pack the item more snugly against the adjacent surface at least in part by using the robotic arm to position and use the end effector to grasp a side surface of the item and slide the item laterally in the direction of the adjacent surface.

4. The system of claim 1, wherein the adjacent surface comprises a side or back wall of a truck or other container in which the plurality of items are being loaded.

5. The system of claim 1, wherein the adjacent surface comprises a side surface of an adjacent one of the plurality of items.

6. The system of claim 1, wherein the processor is further configured to estimate a state of the stack of items based on one or more of the sensor data, attribute data of the respective ones of the plurality of items, and intended placement information for at least a subset of the plurality of items.

7. The system of claim 1, wherein the processor is configured to use the sensor data to detect a gap or instability in the stack; determine a strategy to use the robotic arm to pack the items more densely to eliminate the gap or achieve greater stability; and implement the strategy.

8. The system of claim 1, wherein the sensor data comprises image data.

9. The system of claim 8, wherein the image data is generated by a three-dimensional camera.

10. The system of claim 8, wherein the image data is used to detect excessive deformation of an item during use of the robotic arm to pack the item more snugly against an adjacent surface.

11. The system of claim 1, wherein the sensor data comprises force sensor data.

12. The system of claim 1, wherein the force sensor data is used to detect force feedback indicating that a prescribed magnitude of force has been achieved while packing an item more snugly against an adjacent surface.

13. The system of claim 1, wherein the processor is configured to estimate a state of the stack.

14. The system of claim 13, wherein the processor is further configured to detect based at least in part on the sensor data that an actual state of the stack is not consistent with the estimated a state of the stack; and to take an action in response to detecting that the actual state of the stack is not consistent with the estimated a state of the stack.

15. The system of claim 14, wherein the action comprises a suggested pack action.

16. The system of claim 1, wherein using the robotic arm to pack the item more snugly against an adjacent surface includes moving the item into a position such that two or more items comprising the plurality of items are located below the item.

17. The system of claim 1, wherein the robotic arm comprises a first robotic arm and the processor is further configured to use a second robotic arm in cooperation with the first robotic arm to pack the item more snugly against an adjacent surface.

18. The system of claim 17, wherein the item comprises a first item and the second robotic arm is used to hold a second item in place while the first robotic arm is used to pack the first item more snugly against an adjacent surface.

19. The system of claim 1, wherein the robotic arm comprises an end effector having a retractable pusher structure and the processor is configured to deploy the pusher structure in connection with using the robotic arm to pack the item more snugly against an adjacent surface.

20. The system of claim 1, wherein the robotic arm is used to push multiple items simultaneously to pack the item more snugly against an adjacent surface.

21. A method of using a robotic arm to stack a plurality of items, comprising:
receiving sensor data;
determining, based at least in part on the received sensor data, a plan to use a robotic arm to build a stack of items comprising a plurality of items, the plan including with respect to at least a subset of the items a plan to move the item to an initial position on the stack and then reposition and use the robotic arm to pack the item more snugly against an adjacent surface; and
implement the plan at least in part by sending one or more commands to a robotic arm.

22. A computer program product embodied in a non-transitory computer readable medium and comprising computer instructions for:
receiving sensor data;
determining, based at least in part on the received sensor data, a plan to use a robotic arm to build a stack of items comprising a plurality of items, the plan including with respect to at least a subset of the items a plan to move the item to an initial position on the stack and then reposition and use the robotic arm to pack the item more snugly against an adjacent surface; and
implement the plan at least in part by sending one or more commands to a robotic arm.
